(19) United States
(12) Patent Application Publication
(10) Pub. No.: US 2006/0062688 A1
(43) Pub. Date: Mar. 23, 2006

(54) Bodily fluid analysis system

(75) Inventor: Gregory M. Lawrence, Indianapolis, IN (US)

Correspondence Address: PATTON BOGGS, 1660 LINCOLN ST, SUITE 2050, DENVER, CO, 80264, US

(73) Assignee: Polymer Technology Systems, Inc., Indianapolis, IN (US)

(21) Appl. No.: 11/207,121

(22) Filed: Aug. 17, 2005

Related U.S. Application Data
(63) Continuation-in-part of application No. 10/962,272, filed on Oct. 11, 2004.
(60) Provisional application No. 60/541,681, filed on Feb. 3, 2004.
(60) Provisional application No. 60/602,210, filed on Aug. 17, 2004.

(51) Int. Cl. G01N 31/22

(52) U.S. Cl. 422/56

(57) ABSTRACT

A bodily fluid analyzer including a test strip holder comprising a base and a snap-on cover which completely enclose the test strip except for a sample port in the cover and a sensor port in the base. The test strip is compressed between the base and cover in a sample container having a well-defined sample volume. The test strip comprises a woven dispersement layer, a depth filter containing a reagent, an asymmetrical membrane containing additional reagent, and a colorimetric detection membrane in a vertical stack. The red blood cells are removed from the colorimetric detection area by slowing their vertical movement and stopping flow when the detection membrane is saturated. A minimum value of the reflectance in a color range is used to determine a characteristic of the bodily fluid.

### CROSS-REFERENCE TO RELATED APPLICATIONS

This application is a continuation-in-part of U.S. patent application Ser. No. 10/962,272 filed Oct. 11, 2004, which claims the benefit of U.S. Provisional Application No. 60/541,681 filed Feb. 3, 2004. This application also claims the benefit of U.S. Provisional Application No. 60/602,210 filed Aug. 17, 2004. All of the above patent applications, both provisional and non-provisional, are hereby incorporated by reference to the same extent as though fully contained herein.

### BACKGROUND OF THE INVENTION

1. Field of the Invention

The invention in general relates to bodily fluid analysis systems including a disposable test strip, with particular application to on-site testing of particular analytes in blood.

2. Statement of the Problem

The level of certain analytes in blood and other body fluids is often used to diagnose disease, determine disease risk factors, monitor the course of a therapy, or determine the presence of illicit drugs. In recent years, analytes carried in blood have been evaluated to determine various cholesterol and triglyceride levels as a significant indicator of risk of coronary heart disease. Physicians commonly order what is referred to in the art as a “full lipid panel” for patients to determine the concentration of total cholesterol, high density lipoprotein cholesterol (HDL), low density lipoprotein cholesterol (LDL), and triglycerides.

Clinical chemists prefer to work with blood serum over plasma, and plasma over whole blood, because of the clarity of the sample matrix and the lack of interfering substances from the solid portion of the blood. To facilitate this analysis, a separation step must be carried out since the presence of red blood cells, either intact or hemolyzed, interferes with detection of the signal generated by the chemical reaction performed by the test. Conventionally, the separation of blood components has been carried out by centrifuging a clotted blood sample, and the serum thus obtained is used to carry out the test.

In more recent years, dry test strips have been developed that utilize several layers to separate the blood components, react the plasma with a particular reagent or reagents, and obtain a colorimetric signal indicative of the concentration of the analyte. See, for example, U.S. Pat. No. 5,104,619 entitled “Disposable Diagnostic System”; U.S. Pat. No. 5,166,051 entitled “Membranes, Membrane Overlays, For Exclusion of Erythrocytes, And Method Of Immunoassay of Whole Blood Analytes”; U.S. Pat. No. 4,774,192 entitled “A Dry Reagent Delivery System With Membrane Having Porosity Gradient”; and U.S. Pat. No. 4,477,575 entitled “Process and Composition For Separating Plasma or Serum From Whole Blood”. In more recent systems, the dry test strip is placed within a spectrophotometric device that evaluates the colorimetric response and assigns a quantitative value indicative of the analyte concentration in the blood sample. For example, see U.S. Pat. No. 5,597,532 owned by the assignee of the present invention and entitled “Apparatus For Determining Substances Contained In A Body Fluid”, which patent is incorporated by reference to the same extent as though fully disclosed herein.

All of the above systems depend on flow of the bodily fluid, i.e., blood, through the system as the driving force to separate the unwanted components, e.g., the red blood cells, from the analytes to be tested, e.g., the serum, or, in a system for testing HDL, the other lipoproteins other than HDL. For example, U.S. Pat. No. 4,774,192 relies on a highly porous bottom layer to allow the fluid to flow easily and a dense upper layer to trap the unwanted components. In U.S. Pat. No. 4,477,575, a lateral flow of blood through a fiberglass layer is used to separate the components. U.S. Pat. No. 5,597,532 uses a vertical flow downward through membranes and a lateral flow outward in a lower membrane that is designed to absorb a large amount of fluid to drive the fluid flow. A rectangular test membrane that is significantly larger than the area of the circular opening through which a spectrophotometer reads the strip enhances this feature to encourage flow and prevent blood pooling in the test area of the membrane.

One problem with the test strips of the prior art is that the reagent layer is dosed with a specific mount of reagent based on the anticipated volume of blood sample running through the test strip. If too large a volume of blood is used, reagent that does not react can reconstitute and leach out from the reagent layer. This phenomenon leads to an incorrect color response, and ultimately to an inaccurate reading on the spectrophotometric device. Another problem with the prior dry test strip architectures is that the strips are prone to seepage at the sides of the strip layers. In certain cases, as the blood sample spreads across a strip layer, a certain amount of the sample will seep past the sides of the layer and flow onto the adjacent layer. This cross-contamination can produce erroneous results, especially where the cross-contamination occurs at the reagent layer. Another problem is that the membranes that provide high flow, and thus good separation of the unwanted components from the analytes, such as the asymmetric membranes of U.S. Pat. No. 4,774,192, inherently have low capacity for holding fluid, and thus the problems associated with leaching and seepage are exacerbated.

In addition, test strips of the prior art which have been designed to augment flow have tended to damage the test strip. If the strip is held loosely in the carrier, flow is augmented, but the strip can move, which can lead to erroneous results. Thus, test strip holders have been designed that permit vertical and lateral flow through most of the strip, but tightly hold other parts of the strip. See, for example, U.S. Pat. No. 5,597,532 referenced above. While such holders hold the test strip firmly and at the same time permit flow both vertically and laterally, they can also damage the test strip, which again leads to inaccuracies in measurement.

The conflict between the need for good separation of unwanted components from the analytes, the need to prevent the test strip from moving in the holder, and the problems associated with such flow strip holders, has caused the accuracy of the test strip/spectrophotometric systems to plateau, and has limited the usefulness of this art. Thus, there is a need for a test strip/spectrophotometer architecture that can improve the capabilities of the dry strip technology system and that yield more accurate readings.

### SUMMARY OF THE INVENTION

The present invention provides a solution to the above problems by providing a strip holder that includes a holder base that forms a well that essentially completely encircles the test strip element, and a cover that uniformly contacts the test strip element about the periphery of the element, with the test strip element secured in the well between the cover and base. In this way, stresses that can damage the strip element are avoided. This also prevents leaching, but at the same time impedes lateral flow except for the initial lateral flow that distributes the fluid across the strip, and thus impedes filtering that the prior art believed was necessary. This has lead to a complete rethinking of how a test strip should operate, as discussed in the following.

The present invention also provides a solution to the above problems in that the dry test strip holder provides a sample container for the test strip element that is essentially closed on the bottom and sides so that it holds a well-defined volume of bodily fluid. The invention recognizes for the first time that in such a closed system the unwanted components do not have to be filtered. It is only necessary to slow the flow of the unwanted components as compared to the flow of the desired analytes. That is, in a closed system, once the sample container is filled, flow stops. Thus, if the reaction layer is placed at the bottom of the container, only the fastest flowing components will reach it before flow stops.

It follows from the above that, instead of filtering the red blood cells, for example, it is sufficient to only slow their progress in the flow. Preferably, the progress of the red blood cells is slowed by using membranes that impede the red blood cells but allow the desired analytes to flow easily. Similarly, it is recognized that precipitated or complexed analytes will not flow as readily as analytes in solution. Thus, for example, for an HDL test, if the non-HDL lipoproteins are precipitated or complexed while the HDL lipoproteins are solubilized, the HDL lipoproteins will flow more easily and reach the reaction membrane at the bottom of the sample container before flow stops. Thus, only the HDL lipoproteins will take part in the reaction.

The invention provides a carrier for a diagnostic test strip for use in measuring analyte in a fluid sample, the carrier comprising: a carrier body having a test opening enabling the test strip to be observed; a test strip well formed around the test opening, the well having an upward sloping well wall completely encircling the test opening, the bottom of the well forming a test strip support; a cover having a sample opening, the cover including an outwardly projecting flange completely encircling the sample opening; and engagement elements on the carrier body and the cover configured to engage the cover to the carrier body with the sample opening aligned over the test opening with the test strip secured between the distal end of the flange and the test strip support. Preferably, the flange and the test strip support are configured so that the test strip will be compressed between the distal end of the flange and the test strip support. Preferably, the test strip support further includes a rounded raised lip between the test opening and the well. Preferably, the distal end of the flange is rounded. Preferably, the curvature of at least a portion of the distal end of the flange corresponds to the curvature of at least a portion of the well wall. Preferably, the test strip well is circular, though it may also be rectangular. Preferably, the test strip well is sufficiently large to completely contain the test strip. Preferably, the carrier body and the cover are configured to completely enclose the test strip except for the test opening and the sample opening. In another embodiment, the test strip well is of a depth so that it can contain only a portion of the test strip. Preferably, the engagement elements include a ramp and a groove forming a snap-fit engagement between the base and the cover.

In another aspect, the invention provides a system for determining a characteristic of a bodily fluid, the system being portable and of a size that can be easily held in a human hand, the system comprising: a test strip having a test area and containing a reagent capable of interacting with the bodily fluid to determine the characteristic; a test strip holder comprising: a test holder base having a test strip support supporting the test strip and a sensor port communicating with the test strip; a test holder cap having a sample port and a projecting flange; the test holder base and the cap including an engagement mechanism configured to secure the cap to the base with the test strip held between the flange and the test strip support along essentially the entire periphery of the test area. Preferably, the flange is of a length such that when the cap is secured to the test holder base, the distance between the test strip support and the distal end of the flange is less than the uncompressed thickness of the test strip. Preferably, the test strip support includes a lip that defines a recess between the lip and the container wall. Preferably, the engagement mechanism includes a ramp. Preferably, the test holder base includes a plurality of flexible and resilient fingers. Preferably, the cap includes a groove for receiving the fingers. Preferably, the test holder base, the dry test strip, and the cap form a container having a sidewall and bottom and wherein the sidewall and bottom are essentially impervious to liquid. Preferably, the container and the dry test holder are circular. Preferably, the test holder base and the cap, when engaged, completely enclose the test strip except for the ports. Preferably, the cap further comprises one or more welding tabs extending away from the body of the cap. Preferably, the bodily fluid is blood and the characteristic comprises the concentration of high density lipoproteins or low density lipoproteins in the blood.

In a further aspect, the invention provides a system for determining a characteristic of a bodily fluid, the system being portable and of a size that can be easily held in a human hand, the system comprising: a test strip containing a reagent capable of interacting with the bodily fluid to determine the characteristic; and a test strip holder comprising: a test holder base having a sensor port communicating with the test strip; a test holder cap having a sample port communicating with the test strip, the test holder cap secured to the test holder base with the cap and base completely enclosing the test strip except for the ports. Preferably, the test strip is held between the cap and the base. Preferably, the test strip is compressed between the cap and the base. Preferably, the test strip covers the sensor port and prevents fluid from passing through the sensor port. Preferably, the bodily fluid is blood and the characteristic comprises the concentration of high density lipoproteins or low density lipoproteins in the blood.

In yet a further aspect, the invention provides a method of manufacturing a system for determining a characteristic of a bodily fluid, the system being portable and of a size that can be easily held in a human hand, the method comprising: providing a base having a sensor port, a cap having a sample port, and a test strip; placing the test strip on the base; and securing the cap to the base to form a container completely enclosing the test strip except for the ports. Preferably, the securing includes grasping the test strip between the cap and the base. Preferably, the securing includes compressing the test strip. Preferably, the securing comprises snapping a locking member into a groove. Preferably, the securing comprises sonic welding.

In still another aspect, the invention provides a system for determining a characteristic of a bodily fluid, the system being portable and of a size that can be easily held in a human hand, the system comprising: a container having a sidewall and a bottom enclosing a test volume wherein the sidewall and bottom are essentially impervious to liquid, and at least a portion of the sidewalls or bottom is permeable to gas; a sample port above the container and communicating with the container; a sensor port communicating with the bottom; and a dry test strip in the test volume, the dry test strip containing a reagent capable of interacting with the bodily fluid to determine the characteristic. Preferably, the bottom comprises a material for which the surface tension of the bodily fluid in contact with the material is sufficiently high that the weight of the bodily fluid in the container will cause the bodily fluid to enter the material but not exit the bottom of the material. Preferably, the test strip includes one or more layers, and the bottom of the container is formed by the bottom layer of the test strip. Preferably, the bottom layer of the test strip comprises a nylon membrane in which the net charge can be controlled by changing the pH. Preferably, the test strip includes an asymmetric porous membrane, the asymmetric membrane having a first side and a second side, wherein the average pore size in the first side is larger than the average pore size in the second side, and wherein the first side faces the sample port. Preferably, the bodily fluid is blood and the characteristic comprises the concentration of high density lipoproteins or low density lipoproteins in the blood.

In yet another aspect, the invention provides a method of manufacturing a device for testing of bodily fluids, the method comprising: providing a test strip, the test strip impregnated with chemicals capable of a predetermined colorimetric response to a predetermined bodily fluid, the test strip having sufficient surface tension with respect to the bodily fluid so that the predetermined bodily fluid will pass into the test strip, but not out of it; forming a container having a container bottom and a sensing port formed in the container bottom; placing the test strip in the container so that it covers the sensing port. Preferably, the forming a container comprises forming a fluid impenetrable wall that completely surrounds a sample space, and the placing comprises placing the test strip in the sample space. Preferably, the method further comprises securing a cap on the container while compressing the test strip between the cap and the container.

In another aspect, the invention provides a system for determining a characteristic of a bodily fluid, the system being portable and of a size that can be easily held in a human hand, the system comprising: a container having a sidewall and a bottom enclosing a test volume and a sample port, the sidewall and bottom being essentially impervious to liquid; an asymmetric porous membrane within the test volume; and a dry test strip in the test volume, the dry test strip containing a reagent capable of interacting with the bodily fluid to determine the characteristic. Preferably, the asymmetric porous membrane comprises polysulfone. Preferably, the asymmetric membrane has a first side and a second side, wherein the average pore size in the first side is larger than the average pore size in the second side, and wherein the first side faces the sample port. Preferably, the bodily fluid is blood and the characteristic comprises the concentration of high density lipoproteins or low density lipoproteins in the blood.

In a further aspect, the invention provides a system for determining a characteristic of a bodily fluid, the system being portable and of a size that can be easily held in a human hand, the system comprising: a housing defining a test volume; a sample port in fluidic communication with the test volume; a test strip assembly comprising a first test layer, a second test layer, and a third test layer; the first test layer being closer to the sample port than the second test layer, and the third test layer being farther from the sample port than the second test layer; the first test layer comprising a woven material; the second test layer comprising non-woven fibers; the third test layer comprising an asymmetric membrane; and a reagent in the test volume, the reagent capable of interacting with the bodily fluid to determine the characteristic. Preferably, the asymmetric membrane has a first side and a second side, wherein the average pore size in the first side is larger than the average pore size in the second side, and wherein the first side faces the sample port. Preferably, the asymmetric membrane comprises polysulfone. Preferably, the second test layer comprises a hydroxylated polyester. Preferably, the bodily fluid is blood and the characteristic comprises the concentration of high density lipoproteins or low density lipoproteins in the blood.

The invention also provides a method for determining a characteristic of a bodily fluid; the method comprising: applying a bodily fluid to a portable testing system that can be easily held in a human hand and which includes a sample container containing a test strip; permitting the bodily fluid to flow vertically downward into the container; stopping the flow of the bodily fluid in the container; reacting a portion of the bodily fluid to create a colorimetric indicator of a parameter of the bodily fluid; and reading the colorimetric indicator without removing the bodily fluid or the test strip from the container. Preferably, the method further includes permitting air in the container that is trapped by the bodily fluid to flow out of the bottom of the container. Preferably, the bodily fluid is blood containing red blood cells, and the method further includes slowing the flow of red blood cells in the vertically downward direction. Preferably, the bodily fluid is blood and the characteristic comprises the concentration of high density lipoproteins or low density lipoproteins in the blood. Preferably, the method comprises complexing a lipoprotein in the bodily fluid so that it does not take part in the colorimetric reaction, wherein the complexing is done without precipitating the lipoprotein. Preferably, the complexing comprises exposing the lipoprotein to a reagent comprising dextran sulphate and a divalent metal.

The invention further provides a method of determining a characteristic of a selected one of a plurality of analytes in a bodily fluid, the method comprising: providing the bodily fluid containing the selected analyte and one or more non-selected analytes; reacting the selected one of the analytes with a reactant to provide a colorimetric indication of the characteristic; and, prior to the reacting, preventing the non-selected analytes from participating in the reaction, without precipitating the non-selected analytes.

One benefit achieved by the dry strip architecture of the present invention is that the performance of the strip is essentially volume independent. Since the test strip architecture eliminates the risk of cross-contamination, once the bottom layer of the test strip is saturated, the sample flow stops. Thus, the present invention can accommodate a blood sample as large or larger than the test well. On the other side of the spectrum, the present invention accommodates a sample size essentially as small as the volume of the bottom reaction layer. The present strip architecture limits the fluid expansion area so that the vertical column can be limited to nearly the diameter of the viewing window at the base of the strip. In the preferred embodiment of the invention, the test strip architecture can accept a sample volume as small as 4 ml to as large as 40 ml, while still delivering accurate test results.

Another benefit of the present invention is that the test strip architecture provides greater control over the vertical flow of the sample. As explained above, once the bottom layer of the strip is saturated, sample flow stops which means that the flow of red blood cells also stops. When the flow of RBCs stops, there is no further need for capturing the RBCs. This aspect of the present invention allows the use of a less efficient RBC capturing layer, since the sample flow physics will stop the flow of RBCs at the optimum point.

It is one object of the invention to provide a holder for a diagnostic test strip that can maintain the integrity of the test strip without risking damage to it. Another object is to provide a test strip assembly architecture that can improve the accuracy of the diagnostic output. These and other objects and benefits of the invention will become apparent from the following written description and accompanying figures.

### BRIEF DESCRIPTION OF THE DRAWINGS

FIG. 1 is a perspective view of a preferred embodiment of a spectrophotometric device used in combination with the dry strip technology according to the invention;

FIG. 2 is a perspective view of a preferred embodiment of a test strip assembly according to the invention configured for use with the spectrophotometric device shown in FIG. 1;

FIG. 3 is an exploded perspective view of the test strip assembly of FIG. 2;

FIG. 4 is a top view of a portion of the base portion of the test strip assembly of FIG. 2;

FIG. 5 is a cross-sectional view of the base portion of the test strip assembly of FIG. 2 taken through the line 5-5 of FIG. 4;

FIG. 6 is a top plan view of the cap portion of the test strip assembly of FIG. 2;

FIG. 7 is a bottom plan view of the cap portion of the test strip assembly of FIG. 2;

FIG. 8 is a cross-sectional view of the cap of FIG. 6 taken through the line 8-8 of FIG. 6;

FIG. 9 is a cross-sectional view of the assembled test strip assembly of FIG. 2 taken through the line 9-9 of FIG. 2;

FIG. 10 is an exploded perspective view of a portion of an alternative exemplary embodiment of a test strip assembly according to the invention;

FIG. 11 is a cross-sectional view of the portion of the test strip assembly shown in FIG. 10;

FIG. 12 is a cross-sectional view of a further alternative exemplary embodiment of the test strip holder portion of a test strip according to the invention;

FIG. 13 is a cross-sectional view of an additional exemplary embodiment of the test holder portion of a test strip according to the invention;

FIG. 14 is a cross-sectional view of a test strip assembly according to the invention illustrating some of the features of the invention;

FIG. 15 is a graph showing an exemplary data-derived baseline reflectance versus mg/dl HDL curve from which a reflectance test according to the invention can be generated;

FIG. 16 shows a graph of percent reflectance versus time for a prior art test strip; and

FIG. 17 shows a graph of percent reflectance versus time for a test strip using a test strip holder according to the invention.

### DETAILED DESCRIPTION OF THE PREFERRED EMBODIMENT

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains. It should also be understood that, in accordance with the patent law, the drawings are not intended to be precise engineering drawings of the invention, but rather are only intended to illustrate the invention. For example, the scale of the drawings and relative size of the various parts are generally altered so as to better illustrate the invention within the constraints of a written document such as this.

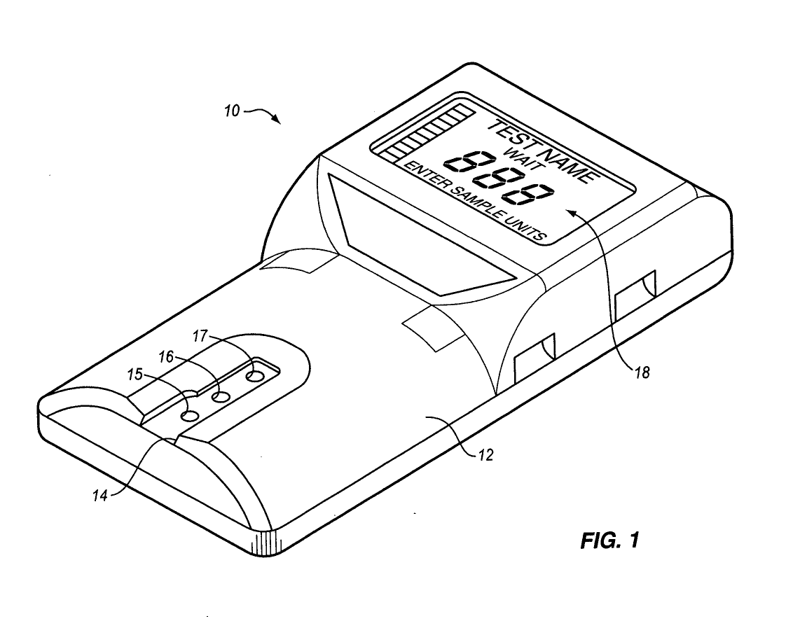

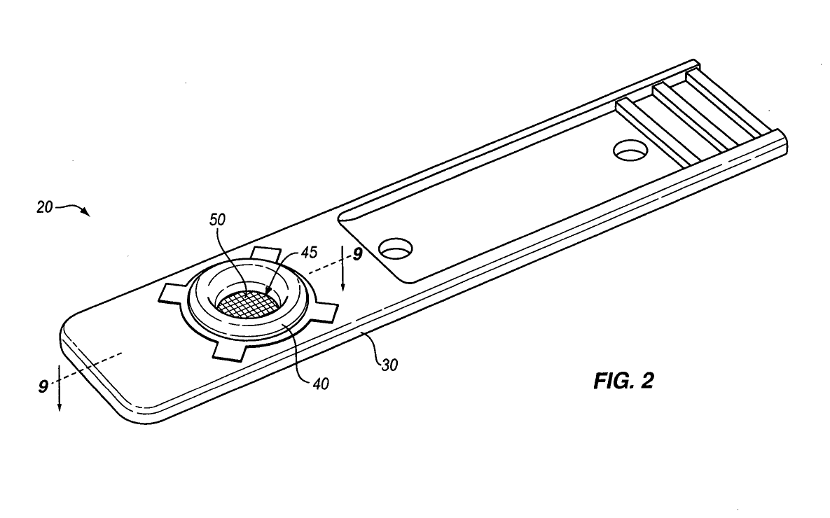

FIG. 1 shows a photometric analyzer 10 according to the preferred embodiment of the invention, and FIG. 2 shows a test assembly 20 according to the preferred embodiment of the invention. The photometric device includes a housing 12 that is sized and configured to be easily hand-held. The housing defines a test assembly holding region 14 that receives a test assembly, such as the assembly 20 shown in FIGS. 2-9. The holding region 14 includes a number of sensor ports 15, 16, and 17 through which light sources and light sensors integrated into the device 10 interact with the test strip 50 (FIG. 2) in test assembly 20. A display 18 provides a visual and/or numeric read-out indicative of the concentration or other parameter of a particular analyte being evaluated. The device 10 includes circuitry and a microprocessor configured to analyze the colorimetric response of the reacted test strip according to known techniques. The preferred photometric device 10 and its operation is more fully described in U.S. Pat. No. 5,597,532, and thus will not be described in detail herein. In the preferred embodiment, the device 10 is the same as the device described in the foregoing patent, except that the device is designed and programmed to operate with the test assembly 20 according to the invention. However, any device that has the ability to determine the intensity of light, the frequency or wavelength of light, or other property of light reflecting, scattered or otherwise interacting with test strip 50, may be used.

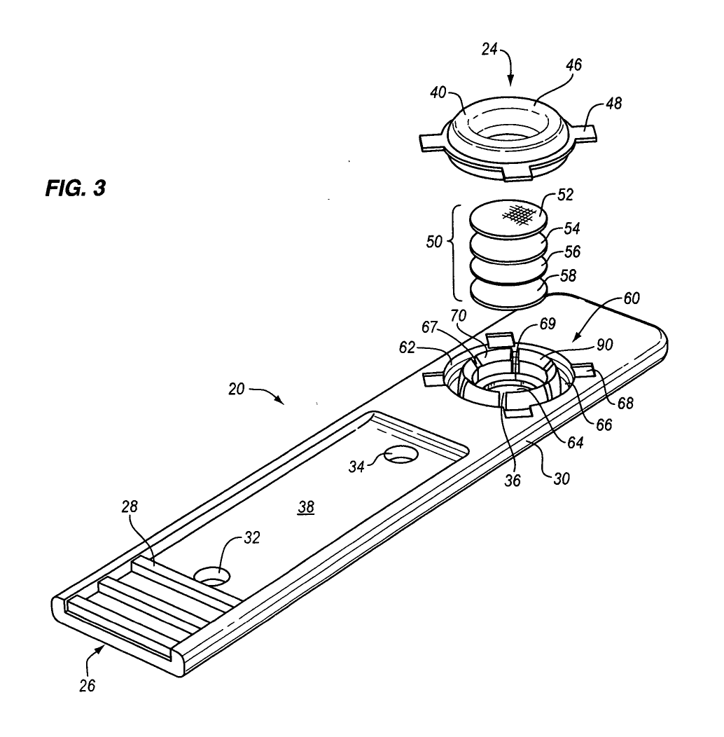

An exploded perspective view of the test assembly 20 is shown in FIG. 3. Test assembly 20 includes a preferably elongated test strip carrier body 30, a test strip 50, and a test strip holder 24. Test strip holder 24 includes a holder base portion 60 and a holder cap 40. Carrier body 30 includes a grip portion 26, openings 32 and 34, sensor port or test opening 36, and holder base 60. Grip portion 26 includes raised ribs 28 which permit the fingers to easily grip the carrier body 30.

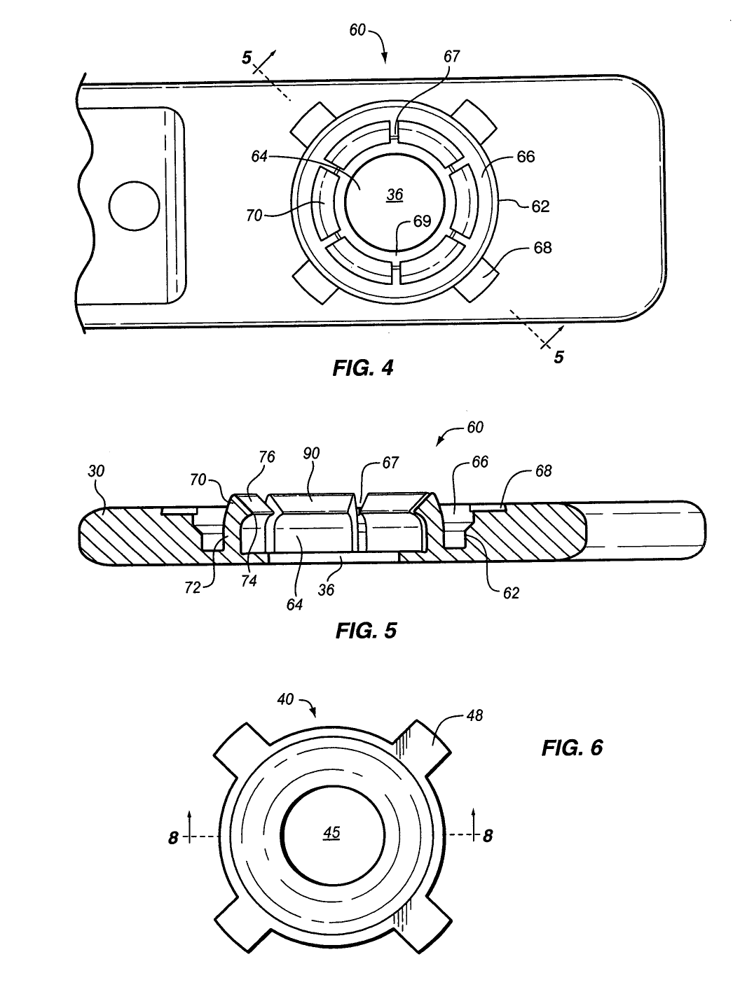

The holder base 60 is shown in FIGS. 3, 4, 5, and 9. FIG. 3 shows a perspective view, FIG. 4 shows a top view, FIG. 5 shows a cross-sectional view through lines 5-5 in FIG. 4, and FIG. 9 shows the cap 40 in place over holder base 60. Preferably, holder base 60 includes a well 62 formed in body 30, alignment recesses 68, and retainer 90, which is preferably flexible. Well 62 has an upward sloping well wall 83 completely encircling the test opening (sensor port) 36. Retainer 90 preferably comprises fingers 70 and separates well 62 into an inner portion 64 which forms a test strip well 62 and an outer portion 66, which is preferably relatively small in volume, being just big enough to allow fingers 70 to flex. In this disclosure, the term “encircle” does not necessarily mean the encircling structure forms a circle, but rather it has the broader common meaning of “to pass completely around”. In the preferred embodiment, however, the well 62 and fingers 70 do form a circle. In the preferred embodiment, there are four alignment recesses 68 and six fingers 70, though the invention contemplates that any number suitable to perform the functions described below may be used. Each finger 70 includes a stem portion 72, a hook portion 74, and a ramp portion 76 that is preferably formed at an acute angle to a vertical line perpendicular to the plan of body 30. Fingers 70 are separated by channels 67. The bottom of well 62 forms a test strip support 69 around port 36 on which, as will be seen below, the test strip 50 rests, as best shown in FIG. 9.

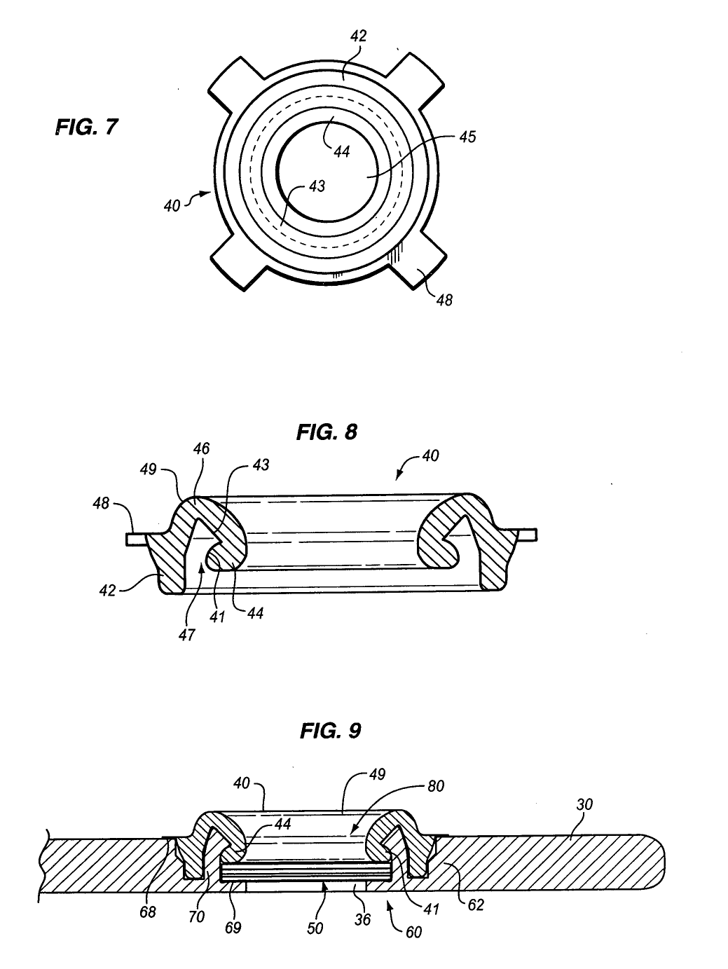

Cap 40 is shown in FIGS. 3 and 6-9. FIG. 3 shows a perspective view, FIG. 6 shows a top plan view, FIG. 7 shows a bottom plan view, FIG. 8 shows a cross-sectional view through line 8-8 of FIG. 6, and FIG. 9 shows a cross-sectional view of the cap 40 in place over the holder base 60. Cap 40 includes an outer foot 42, an inner flange 44, and a connecting portion 46, which, as will be seen below, forms the brim 49 of a bodily fluid container 80. The outer foot 42 and inner flange 44 have different lengths, with the inner flange being shorter. The difference in lengths is less than the thickness of test strip assembly 50, so that the inner flange 44 and test strip support 69 engage strip 50 sufficiently to secure it in place. Preferably, the difference is sufficient so that flange 44 and test strip support 69 compress strip 50 between them. The bottom 43 of connecting portion 46 is shaped to form a groove 47 into which fingers 70 fit snuggly. A lip 41 is formed on flange 44 (FIGS. 8 and 9) which engages hook 72 to latch cap 40 on holder base 60. The distal end 84 of flange 44 is smooth and rounded so as not to damage test strip 50.

Test strip 50 is shown in FIGS. 3 and 9, and is preferably formed of a plurality of layers. Each layer performs a specific function as required by each specific test. Generally, there is a “spreading” layer 52 to ensure even distribution of the whole blood sample; a “separation” layer 56 to obtain a clarified plasma/serum sample; a layer or layers 54 to hold specific test reagents in sequence as needed by each specific assay; and a final “color” or “test reaction” layer 59 to provide a matrix on which a specific color or test reaction will develop for each specific test. The order of the layers can vary. For example, the separation layer may come before or after the reagent layer(s). The details of the test strip layers is described below.

The test strip assembly 20 is assembled as shown in FIG. 3. A cone-shaped inserter (not shown) presses down on the ramps 76 of the fingers 70 and spreads them sufficiently to drop the assembled test strip 50 onto test strip support 69. Cap 40 is then pressed home on retainer 90, with fingers 70 forced into groove 47, compressing test strip 50 sufficiently to hold it in place.

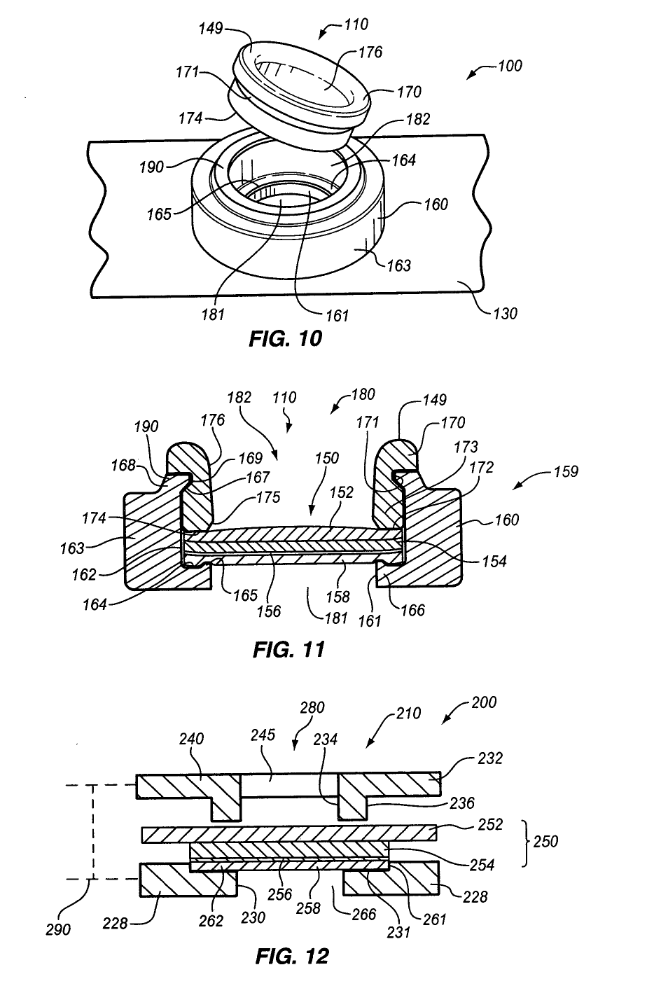

Turning to FIGS. 10 and 11, an alternative preferred embodiment of a test assembly 100 is shown. FIG. 10 shows an exploded perspective view of the alternative test strip holder 110, while FIG. 11 shows a cross-sectional view of holder 110 and test strip 150. In this embodiment of the invention, test strip holder 110 includes a holder base 160 formed on carrier body 130 and a cap 170. Holder base 160 includes a holder wall 163, a lower test strip support 166, and a retainer 190, all of which are preferably circular and integrally formed. Wall 163 is preferably ring-shaped and has a well 162 formed in it. Well 162 has an upward sloping well wall 183 completely encircling test opening 181. Test strip support 166 on the well bottom has a protruding lip 165 defining a recess 164 between the lip and the well wall 183. Retainer 190 includes upper flange 168 having a protruding lip 169 which merges into a downward and inward sloping ramp 167. The inner edge 161 of test strip support 166 defines a test opening or sensor port 181. Test strip 150, which includes layers 152, 154, 156, and 158 rests on the upper surface of test strip support 166.

Cap 170 comprises a preferably ring-shaped cap flange 173 with a brim 149, which is preferably rounded and integrally formed with flange 173. A groove 171 is formed between cap flange 173 and brim 149 that is configured for snap-fit or press-fit engagement with an annular lip 169 and ramp 167 of retainer 190 of the holder base 60. Flange 173 includes a projecting distal end 172 that bears against and compresses the test strip 150 within the well 162. To avoid damage to the test strip, the flange distal end 172 includes an upwardly and radially outwardly sloped edge 174 that merges into an interior radiused edge 175 at the sample opening 176 of the cap. As can be seen in FIG. 11, the test strip 150, and more particularly the upper layer 152, follows the contour of the projecting end 172 when the cap 170 is pressed onto retainer 190. This configuration pinches the test strip layers 152-158 together and creates a vertical blood sample flow path that is essentially limited to the diameter of the test port 181. When test strip 150 is compressed by the cap 170, the lowermost layer 158 conforms to the recess 164 and lip 165, as shown in FIG. 11. The layers 152-158 of the test strip 150 have a diameter slightly less than the inner diameter of the bore 162, but greater than the diameter of the test port 181.

A further alternative embodiment of a test assembly 200 is shown in a cross-sectional view in FIG. 12. This assembly is designed to be clamped by a clamping mechanism of some type, such as snap-lock projections of the prior art test strip holder described in U.S. Pat. No. 5,597,532, which is indicated in ghost at 290. This embodiment is included to illustrate how the prior art assemblies can be modified to include the principles of the invention. Assembly 200 includes a test strip holder 210 and test strip 250. Test strip holder 210 comprises holder base 228 and cap or cover 240. Holder base 228 defines a sensor port or test opening 266 and includes a well 262 formed in its inner and upper edge about the port 266. Well 262 has upward sloping well wall 261 completely encircling test opening 266. Base 228 and well 262 may be a variety of shapes, such as rectangular or circular, though are preferably circular. Test strip 250 is preferably formed of a plurality of layers, such as 252, 254, 256, and 258. Test strip layers 252, 254, 256, and 258 are preferably circular if base 228 and recess 262 are circular, and rectangular if base 228 and recess 262 are rectangular. The bottom layer 258 is just slightly smaller in dimension than the wall 261 of well 262, larger than the inner dimension 230 of port 266, and rests on the bottom 231 of well 262, which bottom forms test strip support 231. One or more layers, such as layer 252, may be of a larger size than bottom layer 258. Cover 240 includes a body 232 and a downward protruding flange 236 which together define a sample application port 245 which may be any desired shape, such as rectangular or circular, but is preferably circular. Preferably, the wall 234 defining port 245 in cover 240 has the same dimension as the wall 230 defining the port 266. If a clamping mechanism of sufficient force is used, test strip 250 is compressed between test strip support 231 and the end of flange 236, and little or no lateral leakage can occur. This confines the flow to a vertical cavity 280 particularly in the important bottom reagent layer 258. If lateral flow does occur, it will be in the upper layers, which is why those layers may be larger to confine the flow.

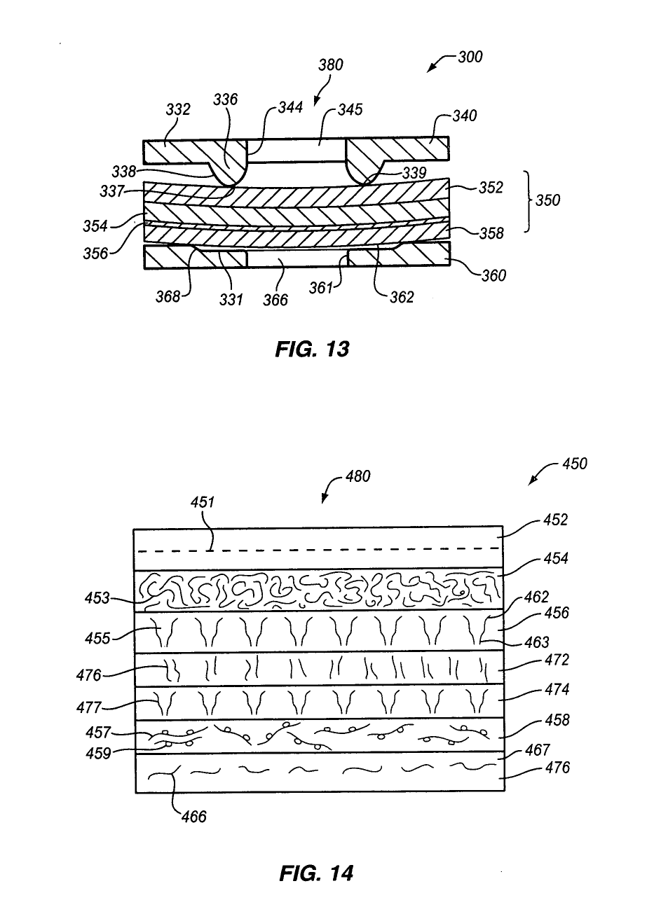

FIG. 13 shows another alternative embodiment of a test assembly 300 according to the invention that illustrates how a prior art test assembly in which all the test strip layers 352, 354, 356, and 358 are larger than the recess 362 and may be modified to include the principles of the invention. Test assembly 300 includes a holder base 360, a holder cap or cover 340, and a test strip 350. Holder base 360 defines a sensor port 366 and includes a well 362 having a bottom or test strip support 331. Well 362 has an upward sloping well wall 368 completely encircling test opening 366. Cover 340 includes a body 332 and a downward protruding flange 336 which together define a sample application port 345 which may be any desired shape, such as rectangular or circular, but is preferably circular. Preferably, the wall 344 defining port 345 in cover 340 has the same dimension as the wall 361 defining port 330. Again, in this embodiment, a clamping mechanism such as the mechanism 290 in FIG. 12 is used. If a clamping mechanism of sufficient force is used, test strip 350 is compressed between test strip support 331 and the end of flange 336. The shape of the end 339 of flange 336 together with the shape of recess 362 tend to trap the fluid in the vertical container 380 defined by the walls 344 and 361 and an extension of the walls through the test strip. That is, the facts that the end 339 of flange 336 is smooth and rounded and the curve of the flange in the region 338 generally conforms to the curve of the well 362 at the outer edge 368 permits sufficient pressure to be put on the test strip assembly 350 to contain the fluid in container 380 without damaging the test strip, and thus little or no lateral leakage can occur. This confines the flow to a vertical cavity 380.

As known in the art, the carrier body 30, 130, etc., holder base 60, 160, 228, 360, and cap or cover 40, 170, 240, 340 are preferably made of plastic or other suitable material. Preferably, the plastic parts are injection molded, and cap 40 is sonic welded to holder base 60 at locator tabs 68. Thus, the placement tabs enable the cap to be welded without contact with the main body of cap 60. Preferably, the plastic parts, particularly the cap 40, are color-coded to correspond to the particular test, such as HDL, LDL, total cholesterol, etc., for which the test strip assembly, such as 50, is designed.

Preferably, for the exemplary HDL test, there are four layers 52, 54, 56, and 58, best shown in FIG. 3. Top layer 52 is preferably a spreading layer designed to disperse the bodily fluid rapidly in all horizontal directions so that it is distributed evenly across the test strip 50. Another function of layer 52 is to distribute the pressure exerted by the cap or cover 40, 170, 240, 340 as evenly as possible across the entire area of the lower layers, such as 54, 56, and 58. Thus, it should be fairly stiff. Preferably, it should be sufficiently stiff to provide a flat surface; that is, a surface with a bulge in the middle of less than 0.002 inches when the cap is in place, but sufficiently flexible to allow the cover to seal the edge of the membranes. Preferably, layer 52 is made of a mesh with either an open or closed weave. Some suitable woven mesh materials are SEFAR™ type 76 SK 022, which is an open mesh with a closed weave, or a Tetko™ mesh, which is a closed mesh, though other suitable and equivalent materials may also be used. An open mesh works by letting the sample through, while a closed mesh works by adhesion of the sample to the mesh threads, i.e., by wicking. Thus, different parameters are required for the different meshes. If an open mesh is used, preferably more than 40% of the total area should be open, and more preferably 50%. If the mesh is a closed mesh, the open area should be 15% or less, and more preferably 10% or less.

The next layer 54 contains the reagents that interact with the non-desired analytes that would compromise the colorimetric test to be performed in layer 58, so that these analytes do not participate in the colorimetric reaction. For example, if the colorimetric test in layer 58 is to be a test for HDL, analytes, such as LDL (low density lipoproteins), VLDL (very low density lipoproteins), ILDL (intermediate density lipoproteins), and chylomicrons (big, tryglyceride-rich lipoproteins), that may make the test less accurate or reliable are interacted with in some way that prevents them form participating in the colorimetric reaction in layer 58. Preferably, the reaction is one in which these analytes are bound in clusters within a compound that prevents them from reacting. The specific reagents are described in copending U.S. patent application Ser. No. 10/962,272 filed Oct. 11, 2004 and U.S. patent application Ser. No. ______ (Patton Boggs Docket No. 23134.0118PTUS) filed on even date herewith, which patent applications are hereby incorporated by reference as though fully disclosed herein.

Layer 54 is also preferably a depth filter, which functions to reconstitute the reagent; that is, get the dried reagent into solution. A key feature of this layer 54 is that it includes many small fibers, and thus it has a large surface area. Preferably, the fibers are random; that is, they are not organized as in a weave. This type of filter is often referred to as a conjugate relief pad, wicking pad, sample pad, or prefilter. The surface area is preferably such that the wicking rate is below 8 seconds per two centimeters. Preferably, the surface area should be such that after wetting with the reagent and drying, the layer holds a weight of dry reagent equal to the membrane weight itself. Preferably, the weight of the dry agent should not be lower than 75% of the weight of the membrane and not above 125% of the weight of the membrane. Since the reagent is on the surface of the fibers, the large surface area helps to reconstitute the reagent faster, since there is a larger area of reagent exposed to the solvent. Preferably, the average pore size of this layer is controlled to optimally control flow through the layer so that the bodily fluid remains long enough to reconstitute the reagent, but not so long as to delay or otherwise hinder the test in layer 58. The controlled pore size in combination with the large surface area helps to limit or retard the movement of the solute in the vertical direction so that it remains in the material longer, and thus has more time to dissolve the reagent. Preferably, layer 54 is made of a non-woven, fibrous material such as a hydroxylated polyester, preferably a polyhydroxylated polyester. Suitable such materials are membranes made by Pall Life Sciences, such as Accuwik Ultra™. Preferably, the membrane is inserted with the bumps side down.

The purpose of the next layer 56 is preferably to remove red blood cells from the analyte liquid and to further add to the reagent/solvent contact time to continue the process of getting the reagent into solution. It is preferably made of an asymmetrically porous material; that is, the pore size varies through the material. Preferably, the side with the large pores is up. In the preferred embodiment, it has a pore size of between 250 microns and 350 microns, and more preferably 300 microns, on the sample-receiving side, and a pore size of between 0.5 microns and 10 microns, and preferably 3 microns, on the detection side. The preferred material is an asymmetric polysulfone such as is BTS-SP-300 or BTS-SP-200 available from Pall Life Sciences, or other suitable materials may be used. Other suitable materials are lechtin-coated graphite fibers, ruthenium oxide fiber, and other materials known in the art. The asymmetric nature of the layer 56 is effective in removing red blood cells while continuing the movement of the solvent and reactant downwards. In the preferred embodiment, it removes the red blood cells by slowing them as they percolate through the tortuous path of the pores. As the pores get smaller, the red blood cells may also become entangled in the fibers, but this happens gradually and relatively randomly throughout the layer, rather than collecting all at one level within the test strip, as they would in a conventional filter with a single pore size; such collecting all at one level tends to block fluid flow. The relatively random entrapment of the red blood cells leaves open capillary paths through the material. Such capillaries assist in drawing the fluid downward through the test strip 50, particularly since the capillaries become smaller in that direction. As will be seen more clearly below, however, it is only necessary to slow the red blood cells to separate them. That is, because the bottom of container 80 is essentially closed, flow stops when the layer 58 becomes saturated. If flow stops and the red blood cells are still in the upper layers, they will remain there.

Bottom layer 58 is the detection layer and contains the detection reagent. It is preferably made of a hydrophobic material which has sufficient surface tension with the analyte bodily fluid so that the fluid will not flow past it. In the preferred embodiment, the test strip assembly layers 52-58 are circular and are all of the same diameter, though other shapes and sizes may be used. The preferred detection layer 58 is the Biodyne™ A membrane available from Pall Corporation with the total cholesterol formulation described in United States Patent Application Publication US 2004/0126830 on application Ser. No. 10/663,555 filed Sep. 16, 2003, which is hereby incorporated by reference to the same extent as though fully disclosed herein. This membrane is a nylon membrane in which the net charge can be controlled by changing the pH. As disclosed in the foregoing reference, the reagents are Trinder reagents which include enzymes, such as cholesterol oxidase, perosidase, and cholesterol esterase, that react with cholesterol to effect a color change which can be detected optically.

FIG. 14 is a cross-sectional view of an alternative test strip assembly 450 according to the invention illustrating some of the features of the invention. Test strip assembly 450 includes layers 452, 454, 456, 472, 474, 458, and 470. Layer 452 comprises a woven mesh 451. Weaves tend to cause fluid to flow more easily along the weave rather than through it, and thus, if the weave 451 is horizontal, layer 454 will tend to distribute the bodily fluid across the layer. Layer 454 can either be a material that traps and holds red blood cells, such as Tuffglass™, or it can be a material such as Accuwick Altra™, that merely slows the red blood cells. Preferably, it includes fibers 453 that are relatively randomly distributed. That is, the fibers 453 are not organized as in a weave. Preferably, the fibers are also very thin; and thus, the layer 454 has a large surface area. This type of material holds a relatively large amount of fluid, and the fluid is in contact with a lot of area. This material functions well to get reagents on the surface of the fibers into solution. Layer 456 is a membrane material. Membranes have pores that are relatively organized. The preferred material of layer 456 is an asymmetric membrane, which means that the pores vary in size. Preferably, in layer 456 the pores are larger at the upper end 462 of the material and smaller at the lower end of the material 463. Note that for illustration purposes the pores are shown in layer 456 as single channels with a varying diameter, but in fact the “channels” are preferably not well-defined and branch in all directions. The important characteristic is that the dimensions of the pores are larger at end 462 than at the other end 463. In the preferred embodiment, the membrane used is more like a depth filter at the top; that is, the material is fiber-like and amorphous. That is, the fibers are disorganized, i.e., essentially randomly distributed. At the bottom, it is membranous with a definite pore size. The layer can be engineered to be more or less depth filter-like at the top and more or less like and absolute membrane at the bottom. The more it is like a depth filter, the more capacity it has. The preferred material is a polysulfone.

Layers 472 and 474 are preferably optional layers used in controlling timing of the reconstitution of the reagent in layer 456. For example, membrane 472 may be a Supor™ 1200 untreated membrane. This example has relatively large 1200 micron pores. It is used to slow down the percolation of the analyte liquid through the assembly to give the reagent introduced in layer 456 more time to dissolve. The smaller the pores in layer 472, the more it slows down the analyte. Layer 474 is an optional layer, preferably having asymmetrical pores 477, that may be identical to layer 456, and is included if it is desired to put more reagent in solution, or to put less reagent in layer 456 so that it dissolves more easily. Layer 458 is a reagent layer which is illustrated by showing a fiber 457 with a reagent 459 on its surface. This reagent is the colorimetric reagent that reacts with the analyte to produce the color, the reflectance of which provides the test result. Layer 476 is a layer in which the individual fibers 466 are preferably hydrophobic, which means they tend to repel water; that is, preferably, water has a high surface tension on the material. Water will tend not to penetrate this material. However gas, such as air, will pass easily through this material. Preferably, the material of layer 476 is an open pore material, and/or also holds a relatively large amount of fluid, as compared to membranes such as 456. However, it also may be an asymmetric membrane with the larger pores on the upper side 467. Such a material tends not to hold large amounts of fluid, but makes the fluid available to the reaction layer 458, as will be discussed in more detail below. Layer 476 is also preferably very thin and/or transparent, particularly when it is saturated with liquid, so that the color in layer 458 can be sensed through it. In the embodiments of FIGS. 2-13, the features of layers 458 and 460 were combined.

The test strip operates generally as follows. A drop of bodily fluid, such as blood, is placed within the sample application port 45 of cap 40. It is evenly dispersed across the opening by test strip layer 52 and percolates vertically downward. The pall membrane 54 separates the unwanted material, such as the red blood cells, from the rest of the fluid, such as the serum. The red blood cell filtration/reagent membrane 56 includes reagents that react with undesired analytes that would compromise the test in membrane 58. For example, if the test in membrane 58 is for HDL, the LDL, ILDL, VLDL, and chylomicron portions of the serum are complexed in membrane 56. The membrane tends to slow or retain the complexed lipoproteins, but allows the HDL to pass to reagent layer 58. The HDL reacts in reagent layer 58 to turn the layer a predetermined color, which is detected by spectrophotometer device 10. However, it is not necessary that membrane 56 retains or even slows the complexed undesired lipoproteins. The complexing itself prevents the undesired analytes from participating in the reaction in test membrane 58 and thus takes these analytes out of the reaction that determines the color. Detailed examples of the chemicals used in the test strip layers and the chemical reactions that take place in the test strip layers are described in copending U.S. patent application Ser. No. 10/962,272 filed Oct. 11, 2004 and U.S. patent application Ser. No. ______ (Patton Boggs Docket No. 023134.0118PTUS) filed on even date herewith. The foregoing patent applications describe the preferred chemistry, which is non-precipitating. However, conventional precipitating chemistry as is known in the art also works well with the system according to the invention, and the invention also provides significant improvements in accuracy when used with the prior art chemistries.

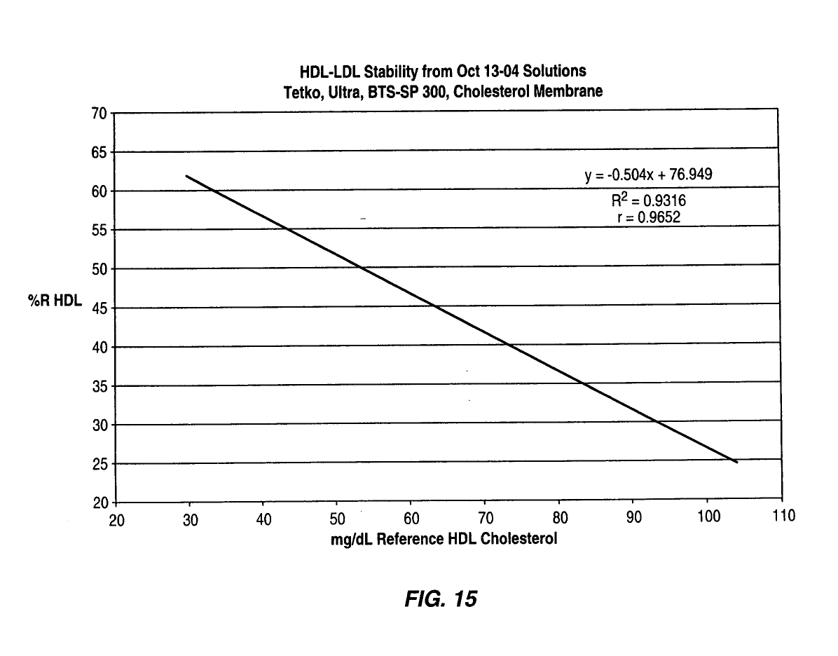

A test strip element 50 was made by assembling a sheet of SEFAR™ type 76 SK 022 and the three sheets discussed above impregnated with chemicals as disclosed in the above-referenced patent applications, and cutting out circular blanks, which were inserted in a test assembly 20 as shown in FIGS. 3-9. A curve as shown in FIG. 15 was then constructed using reflectance measurements from a standard laboratory test for HDL. As known in the art, the curve 515 of FIG. 15 was then used to program a Bioscanner 2000 reader available from Polymer Technology Systems, Inc., Indianapolis, Ind. The reader was then successfully used to directly read HDL concentrations in milligrams per deciliter (mg/dl) from a test assembly as described above.

A feature of the invention is that each layer of the test strip assembly, such as 50 and 450, is engineered to perform specific functions, and at the same time the various layers cooperate so that the test strip assembly as a whole operates to provide more accurate and reliable results. The layers together operate to create a vertical flow of sample liquid essentially across the entire test strip assembly. The red blood cells tend to move slower than the rest of the sample, or get removed from the sample in the layers 54, 56, 454, 456; and therefore, during the time in which the colorimetric reagent is reacting, they will be contained in the layers above the reaction layer and will not be in the reaction layer 58, 458. However, the other analytes may or may not be in the reaction layer 58, 458. Since they are rendered non-reactive by the reagents in layer 54, 454, whether or not they are present is not of great importance. The non-desired analytes are preferably not precipitated, so the pores or channels in the layers 56, 58, 456, 458, and 460 remain open. This allows the sample liquid in the layers 56, 456, 460 adjacent to the reaction layer 58, 458 to participate in the colorimetric reaction. That is, in the embodiment of FIGS. 3-13, the majority of the liquid in a layer, such as 56, just above the layer 58, and, in the embodiment of FIG. 14, the majority of the liquid in the layer 456, just above the layer 458, and the majority of the liquid in the layer 460, just below the layer 458, is free to flow into the reaction layer 58, 458 and take part in the colorimetric reaction. This feature creates a larger volume of treated plasma or other bodily liquid. The larger volume directly results in a more accurate measurement. This feature allows the reaction layer 58, 458 to be much thinner than prior art reaction layers and still yields an accuracy associated with reaction layers that are much thicker.

An important feature of the invention is that the structures of the invention create a sample container, 80, 189, 280, 380, and 480, the sidewalls and bottom of which essentially do not pass liquid, and the top of which is open. This creates several advantages that result in a more accurate and reliable measurement. First, it results in a well-defined test volume of sample fluid. When the bodily fluid is added to the container, it flows to the bottom, and then stops. Only the bodily fluid in the reagent layer, and the adjacent layers in test strips in which the open pore feature discussed above is used, takes part in the reaction. Moreover, at the time of the reaction, this volume is essentially quiescent. Thus, a defined volume of fluid participates in the reaction. This duplicates much more closely the laboratory type test in which a beaker with a defined volume is used in tests, as compared to prior art test strips in which flow, particularly transverse flow, continued to occur during the test, which flow could depend on many variables and was difficult to quantify. Moreover, the fact that flow stops prevents red blood cells from getting through the layers above the test layers. That is, once flow stops, there is no flow or pressure to move the red blood cells. Thus, the layers above the test layer do not have to be completely impenetrable to red blood cells. All they have to do is slow the red blood cells for a while until the test volume is filled. This again plays back into the feature that the red blood cells do not completely block the pores, but permit ease of fluid flow once the reagent is reconstituted. In general, the object of the layers 54 and 56 is to contain the red blood cells in this region and not permit them to get into the reaction layer 58. However, the containment of the red blood cells in layers 54 and 56 does not have to be absolute. Preferably, the containment of the red blood cells is at least 50%, more preferably it is at least 80%, and most preferably at least 95%.

In the inventive test, if more bodily fluid than is required for the test is placed in the sample port, such as 45, the fluid in excess of what is required for the test simply fills up the upper portion of the container, such as 80, and does not affect the test. If the excess is too much even for the container, the excess simply overflows the brim 46 and does not affect the test. Thus, the bodily fluid analysis system according to the invention is much less sensitive to the amount of bodily fluid supplied than prior art systems.

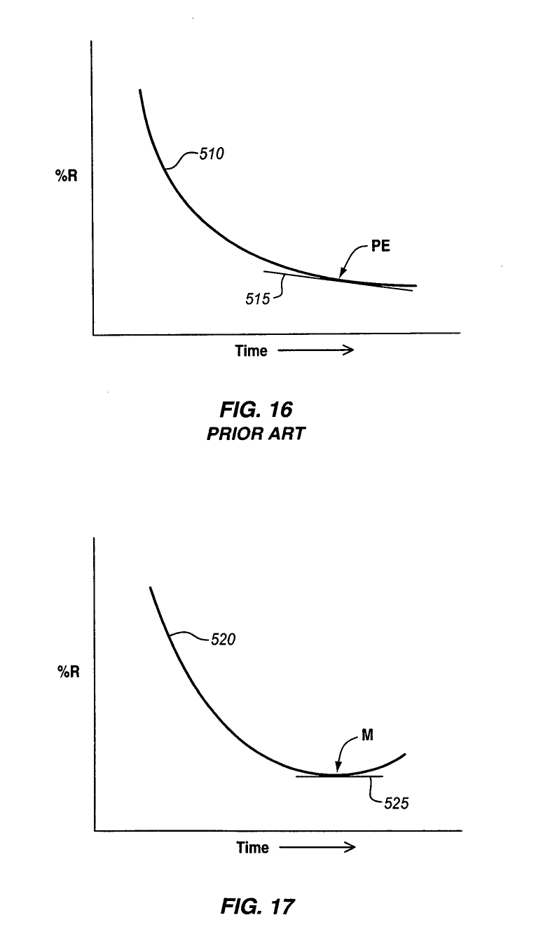

The above feature of the invention, i.e., that the test strip holder 24 provides a sample container 80, 189, 280, 380, and 480, the sidewalls and bottom of which essentially do not pass liquid and therefore the test is performed on a well-defined volume of fluid, also increases the accuracy of the test because it provides a definitive end point to the test. This can be understood by referring to FIGS. 15 and 16. FIG. 15 shows a graph of percent reflectance versus time that is typical of the prior art test strips. As indicated by curve 510, the reflectance changes steeply initially as the reaction progresses rapidly at first, and then begins to level and tapers downward relatively slowly. As disclosed in U.S. Pat. No. 5,597,532, which is incorporated herein by reference as though fully disclosed herein, a pseudo end point PE can be determined from curve 510. The pseudo end point is defined as the point on the curve where the change in percent reflectance per unit time becomes smaller than a predetermined amount; that is, the slope 515 becomes less than a predetermined slope. However, in the prior art after the pseudo end point PE, the curve continues to drop for a considerable time because the reaction continues. This is largely due to the fact that plasma continues to leach through the sides of the strip.

FIG. 16 illustrates a percent reflectance versus time curve 520 for a strip holder according to the invention in which the holder essentially forms a sample container 80, 189, 280, 380, and 480. For this strip holder, the percent reflectance versus time curve 520 reaches a minimum M and then begins to curve upward. This is because only a well-defined amount of plasma takes part in the reaction, and after that plasma reacts, the color begins to fade as the reactants that produce the color oxidize or otherwise begin to break down, and the slope 525 becomes zero. The minimum M defines an effective end point that is much easier to measure than a pseudo end point. For example, one can set the electronics to select the effective end point when the value of percent reflectance increases for a predetermined number of measured points, for example three points each taken a second apart. Generally, one will require more than just one increased value of the percent reflectance to determine the effective end point because random noise and other factors can lead to a single increased value for the curve 520 when the curve is actually still continuing downward. The easier-to-measure minimum M contributes to the increased accuracy of the test strip according to the invention.

Another feature of the invention is that the bottommost layer, such as 58 and 460, which forms the bottom of container 80, 180, 280, 380, 480, preferably does not pass liquid, but passes gases, such as air. This feature prevents air from being trapped at the bottom of the container, such as 80, when the bodily fluid is added. Any air that does not bubble out of the container is forced downward and out of the bottom of the container by the flow of bodily fluid. This removes an unquantifiable variable from the test and makes the test more accurate and reliable.

A feature of the invention is that the portion of the cap that contacts the test trip, e.g., the arm 44, and the portion of the holder base that contacts the test strip, e.g., test strip support 69, engages the entire perimeter of the test strip about the sensor port. A further feature is that the engaging arm 44 and test strip support 69 are essentially directly opposed on either side of the test strip. These features create a uniform pressure on the test strip about its entire perimeter and seal the perimeter. A further feature is that sharp surfaces that engage the test strip are virtually eliminated. The combination of the uniformity of the pressure exerted by the arm, such as 44, and test strip support, such as 69, and the elimination of sharp surfaces eliminate tearing or other damage to the test strip. In the prior art, this damage to the test strip was a significant contribution to test inaccuracies or test failures.

A related feature of the invention is that the test strip holder provides a controlled region for vertical flow of the bodily fluid sample. These features, alone and in combination, eliminate or sharply limit leaching or lateral flow of the sample as bodily fluid flows vertically through the layers. This degree of control translates to the ability to obtain accurate test readings from a reduced blood sample. Accurate results can be obtained with a sample size of as low as 4 ml and as great as 40 ml with the present invention.

A further feature of the invention is that the test strip assembly, such as 50, preferably does not include any glue, adhesive, or other substance to hold it in place. Such substances can get into the test sample and compromise the test to make it less accurate and reliable.

Another feature of the invention is that the reagents used, particularly those in layer 54, are non-hemolytic. That is, they will not rupture the red blood cells. This prevents the matter from inside the red blood cells from compromising the test. Preferably, the reagents are hypertonic; that is, the reagent in solution has a higher osmotic pressure than the osmotic pressure within the red blood cells. Thus, if there is any flow of water, it will be from within the cell to outside the cell. The reverse could cause the cells to gain water until they rupture. However, the reagents are selected so that the degree of hypertonicity is low. Otherwise, the liquid from with the blood cells could dilute the bodily fluid to be analyzed.

Another feature of the invention is that the interrelationship between reagent formulation and the liquid flow in the materials of the test strip layers is considered. That is, the effect of the reagent on the surface tension of the fluid and the effect of the resulting surface tension on the rate of flow through the layers are considered. For example, water will generally not flow easily in the layers according to the invention. The membranes, in particular, tend to hold water like a sponge. However, water with the reagents dissolved flows easily in these membranes. This feature helps keep the liquid in the depth filter until the reagents are dissolved.

The test strips, such as 50, 150, 250, 350, and 450, according to the invention are highly sophisticated compared to the prior art test assemblies. The prior art test strips tended to simply include materials, such as fiberglass, that could hold a large amount of bodily fluid and reagent. They succeeded largely because they used large amounts of both bodily fluid and reagent. In contrast, the test strip assemblies according to the invention utilize many different materials that are carefully chosen and engineered, and they succeed because they better isolate the desired reaction. Because of this, the test strip assemblies of the invention can operate effectively with a much smaller amount of reagent, and thus are more economical than the prior art test strips.

The design methodology of the invention is a self-consistent and self-reinforcing process. The materials and chemical processes of the invention are carefully engineered so that more accurate and more reliable results can be achieved with a smaller amount of reagent and a correspondingly smaller test strip assembly. Because the results that can be achieved are more accurate and can be achieved with a smaller amount of reagent, more flexibility is permitted in the selection of materials in the layers and the reagents. For example, membranes that retain and hold relatively small amounts of liquid can be selected over fabrics that hold large amounts of fluid, while fabrics that hold large amounts of fluid can also be used advantageously where appropriate. The ability to use a wider variety of materials enables the engineer to design a test that is closely akin to a laboratory analysis. That is, laboratory analyses can be very accurate because the order and timing of the reactions can be carefully controlled. One can add an accurately measured amount of a first reactant to an accurately measured amount of solvent, allow a first reaction to occur, then add an accurately measured amount of second reactant and perform a second reaction, and so on. The ability to use a wide variety of different materials allows one to control the order and timing of the reactions in a similar manner. The first reaction is placed closest to the top in the vertical structure of the test strip assembly. The timing of the second reaction can be controlled by choosing the materials of the first reactant layer and the adjoining layers to control the flow time through the layers, and so on.

While the invention has been disclosed in terms of an HDL or LDL direct assay, it will be evident to those skilled in the art that many aspects of the invention will be useful in other assays. Now that a dry test strip assay has been disclosed that mimics many of the features of a laboratory assay, such as use of a well-defined test volume, reaction order and timing controls using a variety of materials, and the ability to remove red blood cells from the reaction while still providing the above two features, these features may also be used to test for total cholesterol, triglycerides, ketones, and many other analytes. Further, now that the advantages of a non-precipitating dry test strip, asymmetric membranes, removal of red blood cells from the detection area without filtering that can clog the system are known, these features can also be advantageously used for testing of other analytes. Further, although the description has disclosed specific exemplary material layers that perform the features of the invention, now that the functions of the layers and the interrelationships of the layers has been described, many other materials can be substituted which will perform the same functions. In addition, while the invention has been disclosed in terms of specific exemplary reactants, many other reactants that perform the same functions and have some or all of the same advantages can be substituted. Again, while the invention has been disclosed in terms of a particular bodily fluid, i.e., blood and blood plasma, many features of the invention will be useful in testing other bodily fluids, such as urine. Thus, the invention should not be limited to these specific structures, layer materials, reactants, and bodily fluids.

While the invention has been illustrated and described in detail in the drawings and foregoing description, the same should be considered as illustrative and not restrictive in character. It is understood that only the preferred embodiments have been presented and that all changes, modifications, and further applications that come within the spirit of the invention are desired to be protected. For instance, while the illustrative embodiments only show a single sample application port and a single corresponding sensor port, multiple sample ports and multiple sensor ports are contemplated.

There has been described a novel invitro, dry test system that is useful to assay for HDL and other analytes. It should be understood that the particular embodiments shown in the drawings and described within this specification are for purposes of example and should not be construed to limit the invention, which will be described in the claims below. Further, it is evident that those skilled in the art may now make numerous uses and modifications of the specific embodiments described, without departing from the inventive concepts. For example, while the ports and test strips have been shown as circular, other shapes may also be used. Additional layers may be added to the test strip assembly. As a further example, any of the caps, such as 60, may be attached to a flap, such as described in U.S. Pat. No. 5,597,532, which would permit the cap, such as 60, and body, such as 30, to be made in a single piece in which the cap and body are connected. This has some advantages in parts management. It is also evident that the methods recited may in many instances be performed in a different order; or equivalent structures and processes may be substituted for the various structures and processes described. Consequently, the invention is to be construed as embracing each and every novel feature and novel combination of features present in and/or possessed by the bodily fluid analysis system herein described.

We claim:

1. A carrier for a diagnostic test strip for use in measuring analyte in a fluid sample, said carrier comprising:
a carrier body having a test opening enabling said test strip to be observed;
a test strip well formed around said test opening, said well having an upward sloping well wall completely encircling said test opening, the bottom of said well forming a test strip support;
a cover having a sample opening, said cover including an outwardly projecting flange completely encircling said sample opening; and
engagement elements on said carrier body and said cover configured to engage said cover to said carrier body with said sample opening aligned over said test opening with the test strip secured between the distal end of said flange and said test strip support.

2. A carrier as in claim 1 wherein said flange and said test strip support are configured so that said test strip will be compressed between the distal end of said flange and said test strip support.

3. A carrier as in claim 1 wherein said test strip support further includes a rounded raised lip between said test opening and said well.

4. A carrier as in claim 1 wherein said distal end of said flange is rounded.

5. A carrier as claim 4 wherein the curvature of at least a portion of said distal end of said flange corresponds to the curvature of at least a portion of said well wall.

6. The carrier of claim 1 in which said test strip well is rectangular.

7. The carrier of claim 1 in which said test strip well is circular.

8. The carrier of claim 1 wherein said test strip well is sufficiently large to completely contain said test strip.

9. The carrier of claim 8 wherein said carrier body and said cover are configured to completely enclose said test strip except for said test opening and said sample opening.

10. The carrier of claim 1 wherein said test strip well is of a depth so that it can contain only a portion of said test strip.

11. The carrier of claim 1 wherein said engagement elements include a ramp and a groove forming a snap-fit engagement between said base and said cover.

12. A system for determining a characteristic of a bodily fluid, said system being portable and of a size that can be easily held in a human hand, said system comprising:
a test strip having a test area and containing a reagent capable of interacting with said bodily fluid to determine said characteristic;
a test strip holder comprising:
a test holder base having a test strip support supporting said test strip and a sensor port communicating with said test strip; and
a test holder cap having a sample port and a projecting flange;
said test holder base and said cap including an engagement mechanism configured to secure said cap to said base with said test strip held between said flange and said test strip support along essentially the entire periphery of said test area.

13. A system as in claim 12 wherein said flange is of a length such that when said cap is secured to said test holder base the distance between said test strip support and the distal end of said flange is less than the uncompressed thickness of said test strip.

14. A system as in claim 12 wherein said test strip support includes a lip that defines a recess between said lip and said container wall.

15. A system as in claim 12 wherein said engagement mechanism includes a ramp.

16. A system as in claim 12 wherein said test holder base includes a plurality of flexible and resilient fingers.

17. A system as in claim 16 wherein said cap includes a groove for receiving said fingers.

18. A system as in claim 12 wherein said test holder base, said dry test strip, and said cap form a container having a sidewall and bottom and wherein said sidewall and bottom are essentially impervious to liquid.

19. A system as in claim 12 wherein said container and said dry test holder are circular.

20. A system as in claim 12 wherein said test holder base and said cap, when engaged, completely enclose said test strip except for said ports.

21. A system as in claim 12 wherein said cap further comprises one or more welding tabs extending away from the body of said cap.

22. A system as in claim 12 wherein said bodily fluid is blood.

23. A system as in claim 22 wherein said characteristic is the concentration of a lipoprotein in said blood.

24. A system for determining a characteristic of a bodily fluid, said system being portable and of a size that can be easily held in a human hand, said system comprising:
a test strip containing a reagent capable of interacting with said bodily fluid to determine said characteristic; and
a test strip holder comprising:
a test holder base having a sensor port communicating with said test strip; and
a test holder cap having a sample port communicating with said test strip;
said test holder cap secured to said test holder base with said cap and base completely enclosing said test strip except for said ports.

25. A system as in claim 24 wherein said test strip is held between said cap and said base.

26. A system as in claim 25 wherein said test strip is compressed between said cap and said base.

27. A system as in claim 24 wherein said test strip covers said sensor port and prevents fluid from passing through said sensor port.

28. A system as in claim 24 wherein said bodily fluid is blood.

29. A system as in claim 28 wherein said characteristic comprises the concentration of one or more lipoproteins in said blood.

30. A method of manufacturing a system for determining a characteristic of a bodily fluid, said system being portable and of a size that can be easily held in a human hand, said method comprising:
providing a base having a sensor port, a cap having a sample port, and a test strip;
placing said test strip on said base; and
securing said cap to said base to form a container completely enclosing said test strip except for said ports.

31. A method as in claim 30 wherein said securing includes grasping said test strip between said cap and said base.

32. A method as in claim 30 wherein said securing includes compressing said test strip.

33. A method as in claim 30 wherein said securing comprises snapping a locking member into a groove.

34. A method as in claim 30 wherein said securing comprises sonic welding.

35. A method as in claim 34 wherein said cap includes a tab extending away from the main body of said cap and said sonic welding comprises welding said tab to said base.

36. A system for determining a characteristic of a bodily fluid, said system being portable and of a size that can be easily held in a human hand, said system comprising:
a container having a sidewall and a bottom enclosing a test volume wherein said sidewall and bottom are essentially impervious to liquid, and at least a portion of said sidewalls or bottom is permeable to gas;
a sample port above said container and communicating with said container;
a sensor port communicating with said bottom; and
a dry test strip in said test volume, said dry test strip containing a reagent capable of interacting with said bodily fluid to determine said characteristic.

37. A system as in claim 36 wherein said bottom comprises a material for which the surface tension of said bodily fluid in contact with said material is sufficiently high that the weight of said bodily fluid in said container will cause said bodily fluid to enter said material but not exit the bottom of said material.

38. A system as in claim 37 wherein said test strip includes one or more layers and the bottom of said container is formed by the bottom layer of said test strip.

39. A system as in claim 37 wherein said bottom layer of said test strip comprises a nylon membrane in which the net charge can be controlled by changing the pH.

40. A system as in claim 36 wherein said test strip includes an asymmetric porous membrane, said asymmetric membrane having a first side and a second side, wherein the average pore size in said first side is larger than the average pore size in said second side, and wherein said first side faces said sample port.

41. A system as in claim 36 wherein said test strip includes a first test layer, a second test layer, and a third test layer; said first test layer being closer to said sample port than said second test layer, and said third test layer being farther from said sample port than said second test layer; and wherein
said first test layer comprising a woven material;
said second test layer comprising non-woven fibers; and
said third test layer comprising said asymmetric membrane.

42. A test system as in claim 36 wherein said container and said test strip are circular.

43. A system as in claim 36 wherein said bodily fluid is blood.

44. A system as in claim 43 wherein said characteristic comprises the concentration of high density lipoproteins in said blood.

45. A system as in claim 43 wherein said characteristic comprises the concentration of low density lipoproteins in said blood.

46. A system as in claim 36 wherein said reagent is a colorimetric reagent.

47. A method of manufacturing a device for testing of bodily fluids, said method comprising:
providing a test strip, said test strip impregnated with chemicals capable of a predetermined colorimetric response to a predetermined bodily fluid, said test strip having sufficient surface tension with respect to said bodily fluid so that said predetermined bodily fluid will pass into said test strip, but not out of it;
forming a container having a container bottom and a sensing port formed in said container bottom; and
placing said test strip in said container so that it covers said sensing port.

48. A method as in claim 47 wherein said forming a container comprises forming a fluid impenetrable wall that completely surrounds a sample space and said placing comprises placing said test strip in said sample space.

49. A method as in claim 47 and further comprising securing a cap on said container while grasping said test strip between said cap and said container.

50. A method as in claim 49 wherein said grasping further comprises compressing said test strip.

51. A system for determining a characteristic of a bodily fluid, said system being portable and of a size that can be easily held in a human hand, said system comprising:
a container having a sidewall and a bottom enclosing a test volume and a sample port, wherein said sidewall and bottom being essentially impervious to liquid;
an asymmetric porous membrane within said test volume; and
a dry test strip in said test volume, said dry test strip containing a reagent capable of interacting with said bodily fluid to determine said characteristic.

52. A system as in claim 51 wherein said asymmetric porous membrane comprises polysulfone.

53. A system as in claim 51 wherein said asymmetric membrane has a first side and a second side, wherein the average pore size in said first side is larger than the average pore size in said second side, and wherein said first side faces said sample port.

54. A system for determining a characteristic of a bodily fluid, said system being portable and of a size that can be easily held in a human hand, said system comprising:
a housing defining a test volume;
a sample port in fluidic communication with said test volume;
a test strip assembly comprising a first test layer, a second test layer, and a third test layer; said first test layer being closer to said sample port than said second test layer, and said third test layer being farther from said sample port than said second test layer;
said first test layer comprising a woven material;
said second test layer comprising non-woven fibers;
said third test layer comprising an asymmetric membrane; and
a reagent in said test volume, said reagent capable of interacting with said bodily fluid to determine said characteristic.

55. A system as in claim 54 wherein said asymmetric membrane has a first side and a second side, wherein the average pore size in said first side is larger than the average pore size in said second side, and wherein said first side faces said sample port.

56. A system as in claim 54 wherein said asymmetric membrane comprises polysulfone.

57. A system as in claim 54 wherein said first test layer comprises a woven mesh.

58. A system as in claim 54 wherein said second test layer comprises a hydroxylated polyester.

59. A system as in claim 54 wherein said bodily fluid is blood.

60. A system as in claim 59 wherein said characteristic comprises the concentration of high density lipoproteins in said blood.

61. A system as in claim 59 wherein said characteristic comprises the concentration of low density lipoproteins in said blood.

62. A method for determining a characteristic of a bodily fluid; said method comprising:
applying a bodily fluid to a portable testing system that can be easily held in a human hand and which includes a sample container containing a test strip;
permitting said bodily fluid to flow vertically downward into said container;
stopping the flow of said bodily fluid in said container;
reacting a portion of said bodily fluid to create an optical indicator of a parameter of said bodily fluid; and
reading said optical indicator without removing said bodily fluid or said test strip from said container.

63. A method as in claim 62 and further including permitting air in said container that is trapped by said bodily fluid to flow out of the bottom of said container.

64. A method as in claim 62 wherein said bodily fluid is blood containing red blood cells and further including slowing the flow of red blood cells in said vertically downward direction.

65. A method as in claim 62 wherein said optical indicator is a colorimetric indicator.

66. A method for determining a characteristic of a bodily fluid; said method comprising:
applying a bodily fluid to a portable testing system that can be easily held in a human hand and which includes a sample container containing a test strip;
reacting a portion of said bodily fluid to create an optical indicator of a parameter of said bodily fluid;
reading a minimum value of said optical indicator over time; and
utilizing said minimum value to determine said characteristic of said bodily fluid.

67. A method as in claim 66 wherein said reading comprises reading a reflectance.

68. A method as in claim 66 wherein said reading comprises reading a colorimetric indicator.
